(19) United States
(12) Patent Application Publication
(10) Pub. No.: US 2015/0104039 A1
(43) Pub. Date: Apr. 16, 2015

(54) APPARATUS AND METHOD OF SUPPRESSING HOWLING

(71) Applicant: ELECTRONICS AND TELECOMMUNICATIONS RESEARCH INSTITUTE, Daejeon (KR)

(72) Inventor: Mi-Suk LEE, Daejeon (KR)

(21) Appl. No.: 14/513,468

(22) Filed: Oct. 14, 2014

(30) Foreign Application Priority Data
Oct. 15, 2013 (KR) 10-2013-0122808

(51) Int. Cl. H04R 3/00; G10L 21/0208

(52) U.S. Cl. CPC H04R 3/002; G10L 21/0208; H04R 2410/03
USPC 381/93

(57) ABSTRACT

Disclosed herein is an apparatus of suppressing howling, including: a microphone sensing a voice of a user to generate a voice signal; a memory storing a command for suppressing howling of the voice signal; and a processor suppressing the howling of the voice signal depending on the command, wherein the command includes a command allowing the following steps to be performed: calculating a first ratio, which is a ratio between a power of the current frame signal for the howling candidate frequency and the short-section average, and a second ratio, which is a ratio between the long-section average and the short-section average; determining the howling candidate frequency to be a howling frequency of the current frame signal; and suppressing the howling of the voice signal depending on the howling frequency.

### CROSS REFERENCE TO RELATED APPLICATION

This application claims the benefit of Korean Patent Application No. 10-2013-0122808 filed on 15 Oct. 2013, entitled “Apparatus and Method of Suppressing Howling”, which is hereby incorporated by reference in its entirety into this application.

### BACKGROUND OF THE INVENTION

1. Technical Field

The present invention relates to a technology of suppressing howling occurring during voice communication, and more particularly, to a technology of suppressing howling occurring through a hands-free voice communication terminal.

2. Description of the Related Art

A hands-free communication has been mainly used at the time of using a system such as a video conference system or a telephone conference system. In the case of using the hands-free video conferencing system, since a microphone and a speaker are positioned in one space, an acoustic feedback loop through which a signal output to the speaker is again input to the microphone is formed, such that howling occurs.

Generally, a hands-free terminal is mounted with an acoustic echo canceller, which serves to decrease a gain of a speaker output signal input to the microphone to suppress occurrence of the howling. However, when an echo path is suddenly changed or a double-talk situation occurs, the echo canceller is not appropriately operated, such that the howling may occur. Therefore, the hands-free terminal uses a notch filter based howling suppression (NHS) method capable of suppressing the howling together with the echo canceller.

### SUMMARY OF THE INVENTION

An object of the present invention is to provide an apparatus and a method of suppressing howling capable of suppressing the howling occurring due to a network delay.

According to an exemplary embodiment of the present invention, there is provided an apparatus of suppressing howling, including: a microphone sensing a voice of a user to generate a voice signal; a memory storing a command for suppressing howling of the voice signal; and a processor suppressing the howling of the voice signal depending on the command, wherein the command includes a command allowing the following steps to be performed: calculating a long-section average and a short-section average of a current frame signal in the voice signal; setting any one of frequencies corresponding to peak powers of the current frame signal on a log-power spectrum as a howling candidate frequency; calculating a first ratio, which is a ratio between a power of the current frame signal for the howling candidate frequency and the short-section average, and a second ratio, which is a ratio between the long-section average and the short-section average; determining the howling candidate frequency to be a howling frequency of the current frame signal in the case in which the first ratio is larger than a first predetermined threshold value and the second ratio is larger than a second threshold value; and suppressing the howling of the voice signal depending on the howling frequency.

The command may further include a command allowing the following steps to be performed: judging whether a howling frequency of a previous frame signal and the howling candidate frequency are the same as each other in the case in which the first ratio is the first predetermined threshold value or less or the second ratio is the second threshold value or less; calculating a third ratio by multiplying a ratio between a long-section average of the previous frame signal and a power of the howling candidate frequency by a weight in the case in which the howling frequency of the previous frame signal and the howling candidate frequency are the same as each other; and determining the howling candidate frequency to be the howling frequency of the current frame signal in the case in which the third ratio is smaller than a third predetermined threshold value.

The command may further include a command allowing the following steps to be performed: setting a first predetermined weight as the weight in the case in which a frequency corresponding to a maximum value among the peak powers is the same as the howling frequency corresponding to the previous frame signal; and setting a second predetermined weight as the weight in the case in which the frequency corresponding to the maximum value among the peak powers is the different from the howling frequency corresponding to the previous frame signal.

The short-section average may be an average of frequency component amplitudes of the current frame signal in a frequency domain, and the long-section average may be an accumulative average of frequency component magnitudes of all frame signals previous to the current frame signal and the current frame signal in the frequency domain.

The setting of any one of the frequencies corresponding to the peak powers of the current frame signal on the log-power spectrum as the howling candidate frequency may include: comparing a corrected power, which is a value obtained by multiplying a maximum value among the peak powers by the weight, with a power of the same frequency, which is a power of a frequency of the current frame that is the same as a howling frequency of a previous frame signal, in the case in which howling has been detected in the previous frame signal and a frequency that is the same as the howling frequency of the previous frame signal is present among the frequencies corresponding to the peak powers; and selecting the howling frequency of the previous frame as the howling candidate frequency of the current frame in the case in which the corrected power is smaller than the power of the same frequency.

The setting of any one of the frequencies corresponding to the peak powers of the current frame signal on the log-power spectrum as the howling candidate frequency may further include: selecting a frequency corresponding to the maximum value among the peak powers as the howling candidate frequency in the case in which howling has not been detected in the previous frame signal, the frequency corresponding to the maximum value among the peak powers is the different from the howling frequency of the previous frame signal, or the corrected power is equal to or larger than the power of the same frequency.

According to another exemplary embodiment of the present invention, there is provided a method of suppressing howling by an apparatus of suppressing howling, including: calculating a long-section average and a short-section average of a current frame signal in a voice signal; setting any one of frequencies corresponding to peak powers of the current frame signal on a log-power spectrum as a howling candidate frequency; calculating a first ratio, which is a ratio between a power of the current frame signal for the howling candidate frequency and the short-section average, and a second ratio, which is a ratio between the long-section average and the short-section average; determining the howling candidate frequency to be a howling frequency of the current frame signal in the case in which the first ratio is larger than a first predetermined threshold value and the second ratio is larger than a second threshold value; and suppressing the howling of the voice signal depending on the howling frequency.

The method of suppressing howling may further include: judging whether a howling frequency of a previous frame signal and the howling candidate frequency are the same as each other in the case in which the first ratio is the first predetermined threshold value or less or the second ratio is the second threshold value or less; calculating a third ratio by multiplying a ratio between a long-section average of the previous frame signal and a power of the howling candidate frequency by a weight in the case in which the howling frequency of the previous frame signal and the howling candidate frequency are the same as each other; and determining the howling candidate frequency to be the howling frequency of the current frame signal in the case in which the third ratio is smaller than a third predetermined threshold value.

The method of suppressing howling may further include: setting a first predetermined weight as the weight in the case in which a frequency corresponding to a maximum value among the peak powers is the same as the howling frequency corresponding to the previous frame signal; and setting a second predetermined weight as the weight in the case in which the frequency corresponding to the maximum value among the peak powers is the different from the howling frequency corresponding to the previous frame signal.

The short-section average may be an average of frequency component amplitudes of the current frame signal in a frequency domain, and the long-section average may be an accumulative average of frequency component magnitudes of all frame signals previous to the current frame signal and the current frame signal in the frequency domain.

The setting of any one of the frequencies corresponding to the peak powers of the current frame signal on the log-power spectrum as the howling candidate frequency may include: comparing a corrected power, which is a value obtained by multiplying a maximum value among the peak powers by the weight, with a power of the same frequency, which is a power of a frequency of the current frame that is the same as a howling frequency of a previous frame signal, in the case in which howling has been detected in the previous frame signal and a frequency that is the same as the howling frequency of the previous frame signal is present among the frequencies corresponding to the peak powers; and selecting the howling frequency of the previous frame as the howling candidate frequency of the current frame in the case in which the corrected power is smaller than the power of the same frequency.

The setting of any one of the frequencies corresponding to the peak powers of the current frame signal on the log-power spectrum as the howling candidate frequency may further include: selecting a frequency corresponding to the maximum value among the peak powers as the howling candidate frequency in the case in which howling has not been detected in the previous frame signal, the frequency corresponding to the maximum value among the peak powers is the different from the howling frequency of the previous frame signal, or the corrected power is equal to or larger than the power of the same frequency.

### BRIEF DESCRIPTION OF THE DRAWINGS

FIG. 1 is a diagram showing an apparatus of suppressing howling according to an exemplary embodiment of the present invention;

FIG. 2 is a flow chart showing a process of suppressing howling by the apparatus of suppressing howling according to an exemplary embodiment of the present invention; and

FIG. 3 is a diagram showing howling occurring in the apparatus of suppressing howling according to an exemplary embodiment of the present invention.

### DESCRIPTION OF EXEMPLARY EMBODIMENTS

The present invention may be variously modified and have several exemplary embodiments. Therefore, specific exemplary embodiments of the present invention will be illustrated in the accompanying drawings and be described in detail in the present specification. However, it is to be understood that the present invention is not limited to a specific exemplary embodiment, but includes all modifications, equivalents, and substitutions without departing from the scope and spirit of the present invention.

Further, in the present specification, it is to be understood that when one component is referred to as “transmitting” a signal to another component, one component may be directly connected to another component to transmit a signal to another component or may transmit a signal to another component through any other components unless explicitly described to the contrary.

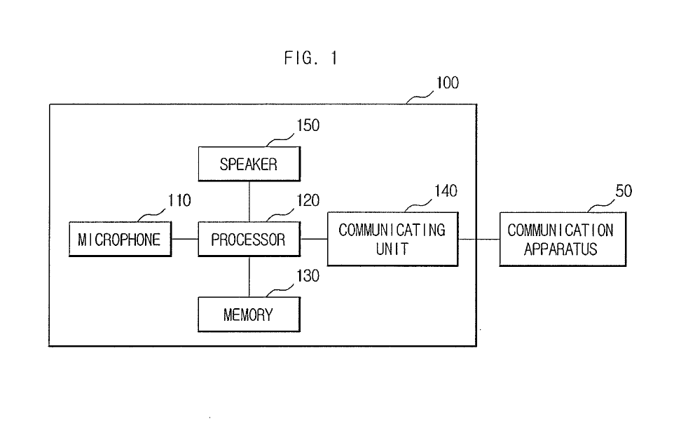

FIG. 1 is a diagram showing an apparatus of suppressing howling according to an exemplary embodiment of the present invention.

Referring to FIG. 1, an apparatus 100 of suppressing howling is configured to include a microphone 110, a processor 120, a memory 130, a communicating unit 140, and a speaker 150. An apparatus 100 of suppressing howling to be described below, which is a hands-free terminal, is connected to a communication apparatus 50 through a communication network to basically provide a voice call function. Therefore, since the apparatus 100 of suppressing howling according to an exemplary embodiment of the present invention uses well-known voice call functions, a detailed description for the voice call functions will be omitted.

The microphone 110 receives a voice of a user, converts the voice into an electrical signal, and transmits the electrical signal to the processor 120.

The processor 120 performs a voice call function with the communication apparatus 50 depending on commands stored in the memory 130. Here, the communication apparatus 50 may be a terminal connected to the apparatus 100 of suppressing howling according to an exemplary embodiment of the present invention to perform the voice call function. Here, the processor 120 senses that howling has occurred while performing the voice call function and transmits a signal from which the howling is suppressed to the speaker 150.

The memory 130 stores commands for the voice call function and sensing and suppression of the howling that are to be performed by the processor 120.

The communicating unit 140 is connected to the communication apparatus 50 through the communication network to transmit and receives signals for a voice call to and from the communication apparatus 50.

The speaker 150 receives the signal from which the howling is suppressed from the processor 120 and outputs the received signal.

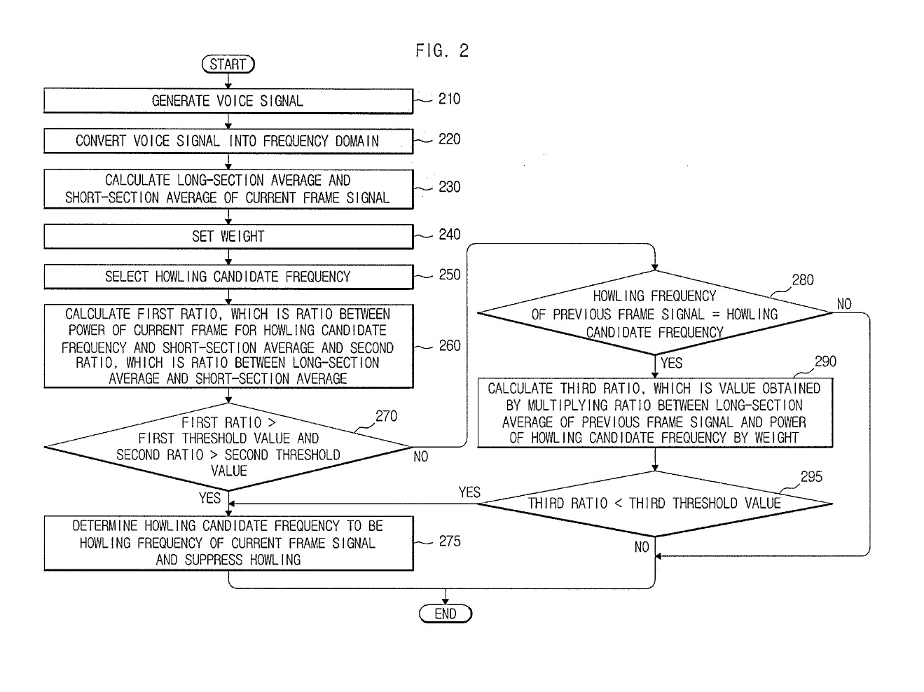

Hereinafter, a process of suppressing howling by the apparatus 100 of suppressing howling depending on the command stored in the memory 130 described above will be described in detail with reference to FIG. 2.

FIG. 2 is a flow chart showing a process of suppressing howling by the apparatus of suppressing howling according to an exemplary embodiment of the present invention. Although each step to be described below is performed by each function unit described above, a subject performing each step will be commonly called the apparatus 100 of suppressing howling in order to clearly and simply describe the present invention. In addition, each step to be described below indicates a howling suppressing process performed by the apparatus 100 of suppressing howling with respect to a single frame signal. Therefore, each step to be described below may be repeatedly performed until a voice call ends.

Referring to FIG. 2, in step 210, the apparatus 100 of suppressing howling generates a voice signal through the microphone 110. In this case, the apparatus 100 of suppressing howling may also perform an operation of outputting a voice signal transmitted from the communication apparatus 50 through the communicating unit 140 through the speaker. Therefore, the apparatus 100 of suppressing howling may sense a sound output through the speaker 150 together with a voice of a user through the microphone 110 to generate the voice signal.

In step 220, the apparatus 100 of suppressing howling converts a voice signal in a predetermined time unit (for example, 10 msec) (hereinafter, referred to as a frame signal) in an entire voice signal into a frequency domain. Hereinafter, a frame signal from which the apparatus 100 of suppressing howling is to currently detect and suppress howling is referred to as a current frame signal.

In step 230, the apparatus 100 of suppressing howling calculates a long-section average and a short-section average of each frame signal. Here, the short-section average is an average of frequency component amplitudes of a corresponding frame signal for an entire frequency in a frequency domain. In addition, the long-section average is an accumulative average of frequency component magnitudes of all frame signals previous to the current frame signal and the current frame signal for the entire frequency in the frequency domain.

In step 240, the apparatus 100 of suppressing howling sets a weight. For example, the apparatus 100 of suppressing howling extracts peak powers of the current frame signal on a log-power spectrum. Here, it is assumed that the number of peak powers is n (n indicates a natural number). The apparatus 1000 of suppressing howling judges whether a frequency corresponding to a maximum value among the n peak powers is the same as a howling frequency corresponding to a frame signal (hereinafter, referred to as a previous frame signal) immediately previous to the current frame signal. Here, it is assumed that the howling frequency of the previous frame signal is stored in the memory 130 in a process of detecting the howling frequency of the previous frame signal. In the case in which the frequency corresponding to the maximum value among the n peak powers is the same as the howling frequency corresponding to the previous frame signal, the apparatus 100 of suppressing howling sets a first predetermined weight as the weight. In the case in which the frequency corresponding to the maximum value among the n peak powers is different from the howling frequency corresponding to the previous frame signal, the apparatus 100 of suppressing howling sets a second predetermined weight as the weight. Here, the first and second weights may be a value equal to and larger than 0 and less than 1.

In step 250, the apparatus 100 of suppressing howling selects a frequency corresponding to one of the n peak powers as a howling candidate frequency. For example, the apparatus 100 of suppressing howling compares a value (hereinafter, referred to as a corrected power) obtained by multiplying the maximum value among the n peak powers by the weight set in step 240 with a power (hereinafter, referred to as a power of the same frequency) of the frequency of the current frame that is the same as the howling frequency of the previous frame in the case in which howling has been detected in the previous frame signal and a frequency that is the same as the howling frequency of the previous frame signal is present among frequencies corresponding to the peak powers. When the corrected power is smaller than the power of the same frequency, the apparatus 100 of suppressing howling selects the howling frequency of the previous frame as the howling candidate frequency of the current frame. The apparatus 100 of suppressing howling selects the frequency corresponding to the maximum value among the n peak powers as the howling candidate frequency in cases other than the above-mentioned case.

In step 260, the apparatus 100 of suppressing howling calculates a first ratio and a second rate. For example, the apparatus 100 of suppressing howling calculates the first ratio, which is a ratio between the power of the current frame for the howling candidate frequency and the short section average, and calculates the second ratio, which is a ratio between the long-section average and the short-section average.

In step 270, the apparatus 100 of suppressing howling judges whether the first ratio is larger than a first predetermined threshold value and the second ratio is larger than a second predetermined threshold value.

In the case in which it is judged in step 270 that the first ratio is larger than the first predetermined threshold value and the second ratio is larger than the second predetermined threshold value, the apparatus 100 of suppressing howling determines the howling candidate frequency to be a howling frequency of the current frame in step 275.

In the case in which it is judged in step 270 that the first ratio is the first predetermined threshold value or less or the second ratio is the second predetermined threshold value or less, the apparatus 100 of suppressing howling judges whether the howling frequency of the previous frame and the howling candidate frequency are the same as each other in step 280.

In the case in which it is judged in step 280 that the howling frequency of the previous frame and the howling candidate frequency are the same as each other, the apparatus 100 of suppressing howling calculates a third ratio, which is a value obtained by multiplying a ratio between the long-section average of the previous frame and the power of the howling candidate frequency by the weight, in step 290.

In the case in which it is judged in step 280 that the howling frequency of the previous frame and the howling candidate frequency are not the same as each other, the apparatus 100 of suppressing howling judges that the howling candidate frequency is not the howling frequency and ends a process of suppressing the howling for the current frame.

In step 295, the apparatus 100 of suppressing howling judges whether the third ratio is smaller than a third predetermined threshold value.

In the case in which it is judged in step 295 that the third ratio is smaller than the third predetermined threshold value, the apparatus 100 of suppressing howling determines the howling candidate frequency to be the howling frequency of the current frame signal, suppresses the howling from the voice signal with reference to the howling frequency, and transmits the voice signal from which the howling is suppressed to the communication apparatus 50 through the communicating unit 140, in step 275. In this case, the apparatus 100 of suppressing howling may suppress the howling with reference to the howling frequency through the well-known notch filter.

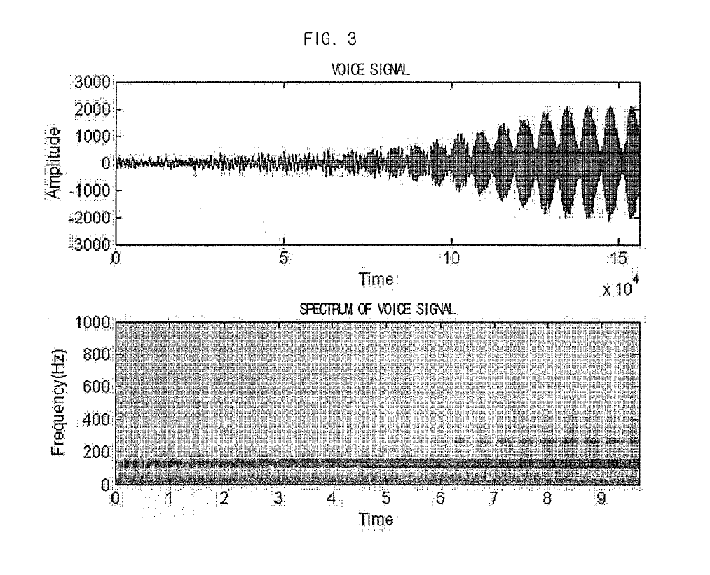

FIG. 3 is a diagram showing howling occurring in the apparatus of suppressing howling according to an exemplary embodiment of the present invention.

Referring to FIG. 3, a voice signal including howling occurring due to a network delay has a tendency that an amplitude thereof is not continuously increased, but is increased and decreased at a predetermined interval, over time. Therefore, it is difficult to accurately detect a howling frequency using only a feature that a specific frequency component of a frequency domain has a power relatively larger than those of other frequency components. The apparatus 100 of suppressing howling according to an exemplary embodiment of the present invention detects the howling using the howling frequency of the howling occurring in the previous frame signal and the long-section average, thereby making it possible to accurately detect the howling frequency in the voice signal having the tendency as shown in FIG. 3. Therefore, the apparatus 100 according to an exemplary embodiment of the present invention suppresses the howling occurring due to the network delay depending on the accurately detected howling frequency, thereby making it possible to stably suppress the howling without being affected by the network delay.

As set forth above, according to exemplary embodiments of the present invention, a section in which the howling occurs due to the network delay is accurately detected, such that the howling may be stably suppressed.

Hereinabove, the present invention has been described with reference to exemplary embodiments thereof. Many exemplary embodiments other than the above-mentioned exemplary embodiments fall within the scope of the present invention. It will be understood by those skilled in the art to which the present invention pertains that the present invention may be implemented in a modified form without departing from essential characteristics of the present invention. Therefore, the exemplary embodiments disclosed herein should be considered in an illustrative aspect rather than a restrictive aspect. The scope of the present invention should be defined by the following claims rather than the above-mentioned description, and all technical spirits equivalent to the following claims should be interpreted as being included in the present invention.

What is claimed is:

1. An apparatus of suppressing howling, comprising:
a microphone sensing a voice of a user to generate a voice signal;
a memory storing a command for suppressing howling of the voice signal; and
a processor suppressing the howling of the voice signal depending on the command,
wherein the command includes a command allowing the following steps to be performed:
calculating a long-section average and a short-section average of a current frame signal in the voice signal;
setting any one of frequencies corresponding to peak powers of the current frame signal on a log-power spectrum as a howling candidate frequency;
calculating a first ratio, which is a ratio between a power of the current frame signal for the howling candidate frequency and the short-section average, and a second ratio, which is a ratio between the long-section average and the short-section average;
determining the howling candidate frequency to be a howling frequency of the current frame signal in the case in which the first ratio is larger than a first predetermined threshold value and the second ratio is larger than a second threshold value; and
suppressing the howling of the voice signal depending on the howling frequency.

2. The apparatus of suppressing howling of claim 1, wherein the command further includes a command allowing the following steps to be performed:
judging whether a howling frequency of a previous frame signal and the howling candidate frequency are the same as each other in the case in which the first ratio is the first predetermined threshold value or less or the second ratio is the second threshold value or less;
calculating a third ratio by multiplying a ratio between a long-section average of the previous frame signal and a power of the howling candidate frequency by a weight in the case in which the howling frequency of the previous frame signal and the howling candidate frequency are the same as each other; and
determining the howling candidate frequency to be the howling frequency of the current frame signal in the case in which the third ratio is smaller than a third predetermined threshold value.

3. The apparatus of suppressing howling of claim 2, wherein the command further includes a command allowing the following steps to be performed:
setting a first predetermined weight as the weight in the case in which a frequency corresponding to a maximum value among the peak powers is the same as the howling frequency corresponding to the previous frame signal; and
setting a second predetermined weight as the weight in the case in which the frequency corresponding to the maximum value among the peak powers is the different from the howling frequency corresponding to the previous frame signal.

4. The apparatus of suppressing howling of claim 1, wherein the short-section average is an average of frequency component amplitudes of the current frame signal in a frequency domain, and
the long-section average is an accumulative average of frequency component magnitudes of all frame signals previous to the current frame signal and the current frame signal in the frequency domain.

5. The apparatus of suppressing howling of claim 1, wherein the setting of any one of the frequencies corresponding to the peak powers of the current frame signal on the log-power spectrum as the howling candidate frequency includes:
comparing a corrected power, which is a value obtained by multiplying a maximum value among the peak powers by the weight, with a power of the same frequency, which is a power of a frequency of the current frame that is the same as a howling frequency of a previous frame signal, in the case in which howling has been detected in the previous frame signal and a frequency that is the same as the howling frequency of the previous frame signal is present among the frequencies corresponding to the peak powers; and
selecting the howling frequency of the previous frame as the howling candidate frequency of the current frame in the case in which the corrected power is smaller than the power of the same frequency.

6. The apparatus of suppressing howling of claim 5, wherein the setting of any one of the frequencies corresponding to the peak powers of the current frame signal on the log-power spectrum as the howling candidate frequency further includes: selecting a frequency corresponding to the maximum value among the peak powers as the howling candidate frequency in the case in which howling has not been detected in the previous frame signal, the frequency corresponding to the maximum value among the peak powers is the different from the howling frequency of the previous frame signal, or the corrected power is equal to or larger than the power of the same frequency.

7. A method of suppressing howling by an apparatus of suppressing howling, comprising:
calculating a long-section average and a short-section average of a current frame signal in a voice signal;
setting any one of frequencies corresponding to peak powers of the current frame signal on a log-power spectrum as a howling candidate frequency;
calculating a first ratio, which is a ratio between a power of the current frame signal for the howling candidate frequency and the short-section average, and a second ratio, which is a ratio between the long-section average and the short-section average;
determining the howling candidate frequency to be a howling frequency of the current frame signal in the case in which the first ratio is larger than a first predetermined threshold value and the second ratio is larger than a second threshold value; and
suppressing the howling of the voice signal depending on the howling frequency.

8. The method of suppressing howling of claim 7, further comprising:
judging whether a howling frequency of a previous frame signal and the howling candidate frequency are the same as each other in the case in which the first ratio is the first predetermined threshold value or less or the second ratio is the second threshold value or less;
calculating a third ratio by multiplying a ratio between a long-section average of the previous frame signal and a power of the howling candidate frequency by a weight in the case in which the howling frequency of the previous frame signal and the howling candidate frequency are the same as each other; and
determining the howling candidate frequency to be the howling frequency of the current frame signal in the case in which the third ratio is smaller than a third predetermined threshold value.

9. The method of suppressing howling of claim 8, further comprising:
setting a first predetermined weight as the weight in the case in which a frequency corresponding to a maximum value among the peak powers is the same as the howling frequency corresponding to the previous frame signal; and
setting a second predetermined weight as the weight in the case in which the frequency corresponding to the maximum value among the peak powers is the different from the howling frequency corresponding to the previous frame signal.

10. The method of suppressing howling of claim 7, wherein the short-section average is an average of frequency component amplitudes of the current frame signal in a frequency domain, and
the long-section average is an accumulative average of frequency component magnitudes of all frame signals previous to the current frame signal and the current frame signal in the frequency domain.

11. The method of suppressing howling of claim 7, wherein the setting of any one of the frequencies corresponding to the peak powers of the current frame signal on the log-power spectrum as the howling candidate frequency includes:
comparing a corrected power, which is a value obtained by multiplying a maximum value among the peak powers by the weight, with a power of the same frequency, which is a power of a frequency of the current frame that is the same as a howling frequency of a previous frame signal, in the case in which howling has been detected in the previous frame signal and a frequency that is the same as the howling frequency of the previous frame signal is present among the frequencies corresponding to the peak powers; and
selecting the howling frequency of the previous frame as the howling candidate frequency of the current frame in the case in which the corrected power is smaller than the power of the same frequency.

12. The method of suppressing howling of claim 11, wherein the setting of any one of the frequencies corresponding to the peak powers of the current frame signal on the log-power spectrum as the howling candidate frequency further includes:
selecting a frequency corresponding to the maximum value among the peak powers as the howling candidate frequency in the case in which howling has not been detected in the previous frame signal, the frequency corresponding to the maximum value among the peak powers is the different from the howling frequency of the previous frame signal, or the corrected power is equal to or larger than the power of the same frequency.
